(19) United States
(12) Patent Application Publication
(10) Pub. No.: US 2015/0379530 A1
(43) Pub. Date: Dec. 31, 2015

(54) DRIVING BUSINESS TRAFFIC BY PREDICTIVE ANALYSIS OF SOCIAL MEDIA

(71) Applicant: International Business Machines Corporation, Armonk, NY (US)

(72) Inventors: James E. Bostick, Cedar Park, TX (US); John M. Ganci, JR., Cary, NC (US); Kimberly G. Starks, Nashville, TN (US); Craig M. Trim, Glendale, CA (US)

(21) Appl. No.: 14/315,791

(22) Filed: Jun. 26, 2014

(51) Int. Cl. G06Q 30/02; G06Q 50/00

(52) U.S. Cl. CPC G06Q 30/0202; G06Q 50/01

(57) ABSTRACT

According to a business requirement, a set of characteristics of a market is computed. The market comprises a group of potential buyers of a product. In a social medium, the market is identified. A data source operates in the market in the social medium. Data corresponding to the data source in the social medium is analyzed to identify a set of attributes of an event occurring in the social medium. An attribute in the set of attributes is correlated with the product. An information associated with a business application is manipulated such that a search result showing an availability of the product from the business application is promoted in a set of search results produced by a search engine, wherein the set of search results is responsive to a search related to the event in the social medium.

### TECHNICAL FIELD

The present invention relates generally to a method, system, and computer program product for increasing sales opportunities using social media. More particularly, the present invention relates to a method, system, and computer program product for driving business traffic by predictive analysis of social media.

### BACKGROUND

Any goods or services that can be sold or traded is collectively referred to herein as a product. A business enterprise that sells or trades in a product online uses a business application. In the most common case, presently, such a business application is a website that includes tools, applications, and features to enable the sale, purchase, or trade of the product between the business enterprise and a user.

Social media comprises any medium, network, channel, or technology for facilitating communication between a large number of individuals and/or entities (users). Some common examples of social media are Facebook or Twitter, each of which facilitates communications in a variety of forms between large numbers of users (Facebook is a trademark of Facebook, Inc. in the United States and in other countries. Twitter is a trademark of Twitter Inc. in the United States and in other countries.) Social media, such as Facebook or Twitter allow users to interact with one another individually, in a group, according to common interests, casually or in response to an event or occurrence, and generally for any reason or no reason at all.

Some other examples of social media are websites or data sources associated with radio stations, news channels, magazines, publications, blogs, and sources or disseminators of news or information. Some more examples of social media are websites or repositories associated with specific industries, interest groups, action groups, committees, organizations, teams, or other associations of users.

Data from social media comprises unidirectional messages, or bi-directional or broadcast communications in a variety of languages and forms. Such communications in the social media data can include proprietary conversational styles, slangs or acronyms, urban phrases in a given context, formalized writing or publication, and other structured or unstructured data.

Natural language processing (NLP) is a technique that facilitates exchange of information between humans and data processing systems. For example, one branch of NLP pertains to answering questions about a subject matter based on information available about the subject matter domain.

Information about a domain can take many forms and can be sourced from any number of data sources. The presenter of the information generally selects the form and content of the information. Before information can be used for NLP, generally, the information has to be transformed into a form that is usable by an NLP engine.

### SUMMARY

The illustrative embodiments provide a method, system, and computer program product for driving business traffic by predictive analysis of social media. An embodiment includes a method for driving business traffic by predictive analysis of social media. The embodiment computes, according to a business requirement, a set of characteristics of a market, wherein the market comprises a group of potential buyers of a product. The embodiment identifies in a social medium, the market, wherein a data source operates in the market in the social medium. The embodiment analyzes a data corresponding to the data source in the social medium to identify a set of attributes of an event occurring in the social medium. The embodiment correlates an attribute in the set of attributes with the product. The embodiment manipulates an information associated with a business application such that a search result showing an availability of the product from the business application is promoted in a set of search results produced by a search engine, wherein the set of search results is responsive to a search related to the event in the social medium.

Another embodiment includes a computer program product for driving business traffic by predictive analysis of social media. The embodiment further includes one or more computer-readable tangible storage devices. The embodiment further includes program instructions, stored on at least one of the one or more storage devices, to compute, according to a business requirement, a set of characteristics of a market, wherein the market comprises a group of potential buyers of a product. The embodiment further includes program instructions, stored on at least one of the one or more storage devices, to identify in a social medium, the market, wherein a data source operates in the market in the social medium. The embodiment further includes program instructions, stored on at least one of the one or more storage devices, to analyze a data corresponding to the data source in the social medium to identify a set of attributes of an event occurring in the social medium. The embodiment further includes program instructions, stored on at least one of the one or more storage devices, to correlate an attribute in the set of attributes with the product. The embodiment further includes program instructions, stored on at least one of the one or more storage devices, to manipulate an information associated with a business application such that a search result showing an availability of the product from the business application is promoted in a set of search results produced by a search engine, wherein the set of search results is responsive to a search related to the event in the social medium.

Another embodiment includes a computer system for driving business traffic by predictive analysis of social media. The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to compute, according to a business requirement, a set of characteristics of a market, wherein the market comprises a group of potential buyers of a product. The embodiment further includes program instructions, stored on at least one of the one or more storage devices for execution by at least one of the one or more processors via at least one of the one or more memories, to identify in a social medium, the market, wherein a data source operates in the market in the social medium. The embodiment further includes program instructions, stored on at least one of the one or more storage devices for execution by at least one of the one or more processors via at least one of the one or more memories, to analyze a data corresponding to the data source in the social medium to identify a set of attributes of an event occurring in the social medium. The embodiment further includes program instructions, stored on at least one of the one or more storage devices for execution by at least one of the one or more processors via at least one of the one or more memories, to correlate an attribute in the set of attributes with the product. The embodiment further includes program instructions, stored on at least one of the one or more storage devices for execution by at least one of the one or more processors via at least one of the one or more memories, to manipulate an information associated with a business application such that a search result showing an availability of the product from the business application is promoted in a set of search results produced by a search engine, wherein the set of search results is responsive to a search related to the event in the social medium.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration usable for driving business traffic by predictive analysis of social media in accordance with an illustrative embodiment;

FIG. 4 depicts an example process for driving business traffic by predictive analysis of social media in accordance with an illustrative embodiment;

FIG. 5 depicts a flowchart of another process for using the business traffic data in accordance with an illustrative embodiment.

### DETAILED DESCRIPTION

Traditionally, product sales are driven by advertising. One type of advertising is direct advertising, which is an overt appeal to a user's sensibilities. For example, direct advertising is accomplished by a business enterprise making clearly purposed advertisement of their product's utility, benefits, competitive advantage and the like. A business enterprise's own business application is also an example of direct advertising because business enterprises often use the same application, e.g., their website, to not only sell their products but to advertise them as well.

Other advertising is indirect and subtle—not as clear or direct an appeal but designed to register in the user's subconscious. Product placement is an example of indirect advertising, where the business enterprise pays have their product strategically placed in the context of another product, such as in a television show. Product placement and indirect advertising of other types are also designed to create a buzz about the involved products.

Business traffic according to the illustrative embodiments comprises a number of demands for a given product a business enterprise receives at their business application. The illustrative embodiments recognize that presently, the business traffic to a business application is driven largely by the business enterprise advertising their products in the above-described ways. In other words, present methods of driving business traffic depend on the actions of a business enterprise or their advertisers, whether to appeal to a user, to subconsciously persuade a user, or to create a buzz or hype about their products.

The illustrative embodiments recognize that often in social media, users discuss products unprompted—either directly or indirectly—by the business enterprise or their advertisers. For example, a news anchor wearing a particular item of clothing during a broadcast can be the subject of discussion between users in social media, where the manufacturer, the retailer, or an advertiser of that item of clothing has no direct or indirect advertising purpose in the broadcast. As another example, a celebrity's hair can become a hot topic of discussion in social media, and drive up demand for hair care products without any direct or indirect advertising efforts. People discussing a car problem on social media after coverage of the problem on an automotive talk show can similarly increase business traffic for certain car-care services or products.

The illustrative embodiments recognize that some products become a topic of discussion in social media without direct or indirect advertising, and therefore without an effort by the business enterprise to increase the sale of those products. Such topics of discussion and the resulting popularity of the product sometimes catch the business enterprise trading in that product by surprise, resulting in lost sales opportunities. There are many stories where a product has become a topic of discussion in social media, resulting in users scooping up all available quantities of the product, and resulting in a shortage of the product.

The illustrative embodiments recognize that such spontaneous, unintentional, or involuntary social media phenomenon, although resulting in a windfall for some business enterprises also has certain drawbacks. Because the business enterprise is unaware of the rising demand for the product, the business enterprise is ill-prepared with sufficient quantities to address the spike in the demand, resulting in lost sales opportunities. Furthermore, the business application may not be suitably configured to handle the increased business traffic, sometimes losing sales opportunities because of website crash, sluggish performance, poor user experience, and the like.

The illustrative embodiments used to describe the invention generally address and solve the above-described problems and other problems related to addressing non-advertising driven social media based demand for products. The illustrative embodiments provide a method, system, and computer program product for driving business traffic by predictive analysis of social media.

An embodiment determines a set of market characteristics for a product based on the business requirements of the business enterprise about the product. For example, a business enterprise may specify a geographical area where they want to sell the product, a return-on-investment threshold that must be met if an expense is incurred to sell or market the product there, and other similarly purposed criteria.

A market characteristic comprises a defining feature of a market for a product. For example, a size of the market, e.g., a number of potential buyers of a product, is an example feature or characteristic of the market for the product. A demographic breakdown of the geographical region of a market, such as by age-group or types of professions, is also a market characteristic. The example market characteristics are described only for the clarity of the description and not as limitations on the illustrative embodiments. Those of ordinary skill in the art will be able to use this disclosure to conceive many other market characteristics that can be used in conjunction with an embodiment described herein, and the same are contemplated within the scope of the illustrative embodiments.

Based on the set of market characteristics, an embodiment identifies a set of social media data sources that create, affect, influence, or otherwise participate in the market that bears the set of market characteristics. For example, assume that an example market characteristic were simply a number of participants in the market, e.g., at least twenty thousand users. A social media data source identified by an embodiment can be a social media user with a following of twenty thousand users or more.

Assume that another example set of market characteristics includes the number of participants and an industry, e.g., twenty thousand users and the fashion industry. Now an embodiment might identify as a social media data source a social media user, e.g., a fashion critic or designer with a following of twenty thousand users or more.

Assume that another example set of market characteristics includes the number of participants, an industry, and a geographical region, e.g., twenty thousand users, the fashion industry, and New York. Now an embodiment would identify as a social media data source a social media user, e.g., a fashion critic or designer based in New York with a following of twenty thousand users or more.

Note that all social media data sources need not match all market characteristics. Assume that another example set of market characteristics includes the number of participants, two industries, and a geographical area, e.g., twenty thousand users, the fashion industry and the automotive industry, and New York. Now an embodiment can identify as one social media data source a social media user, e.g., a fashion critic or designer with a following of twenty thousand users or more. The embodiment can identify as another social media data source a social media user, e.g., an auto-show organizer group's social media page with a following of twenty thousand users or more.

The example social media data sources and their selection logic are described only for the clarity of the description and not as limitations on the illustrative embodiments. Those of ordinary skill in the art will be able to use this disclosure to conceive many other social media data sources and logic for their selection that can be used in conjunction with an embodiment described herein, and the same are contemplated within the scope of the illustrative embodiments.

An embodiment monitors the social media data generated by, for, or involving the identified social media data sources. The embodiment identifies events occurring in the social media data. For example, the embodiment submits the collected social media data to an NLP engine to extract the events out of the social media data. For example, the NLP engine can be configured using known technology to identify a subject, topic, or occurrence to with some or all of the data pertains. Such subject or occurrence forms an event. The NLP engine is also able to identify one or more attributes of the event from the social media data. The event and the event attributes collectively form event data according to the illustrative embodiments.

An embodiment identifies a product whose sales can be increased as a result of an event. For example, the embodiment correlates one or more event attributes with one or more product parameters, such as keywords, tags, metadata components, synonyms, descriptive words or phrases, classification, category, type, or other similarly purposed parameters associated with a product. If the correlation results in a greater than threshold number of event attributes matching the product parameters, the embodiment identifies the product as one whose sales can be increased due to the event.

One embodiment performs this correlation and product identification while the event is trending in the social media data. For example, if the discussions of a certain occurrence have just begun in the social media and are on the rise, the event related to the occurrence is said to be trending upwards in the social media data. Performing the correlation while the event is trending is a way of predictively forecasting of the demand for the product according to an embodiment for when the event trend reaches a next level.

Once the product correlated to the event has been identified, an embodiment identifies a business enterprise trading in that product. The identified business enterprise may be the same or different from a source of the business requirements described earlier. An embodiment identifies a business application associated with an identified business enterprise. The embodiment determines whether a cost associated with increasing the business traffic to the identified business application is justified by the increased business traffic expected to be seen at the business application, and the consequent increase in the sales of the product via the business application. In other words, the embodiment determines whether the cost associated with increasing the business traffic has an acceptable ROI for the identified business enterprise.

If the ROI to the business enterprise is acceptable, an application modifies or manipulates a part of the associated business application, performs an action relative to the business application, or a combination thereof. For example, one embodiment modifies a metadata of the product page on a web server type business application such that the searches performed by users as a result of the event will find the product page due to the modified metadata. As another example, another embodiment causes the business application to be upgraded to a premium or featured listing so that the searches performed by users as a result of the event will preferentially find the product page. As another example, another embodiment causes the business application to be listed in a subject-matter specific category so that the searches performed by users as a result of the event will find the product page due in that category.

The example manipulations in or relative to a business application are described only for the clarity of the description and not as limitations on the illustrative embodiments. Those of ordinary skill in the art will be able to use this disclosure to conceive many other similarly purposed manipulations that can be used in conjunction with an embodiment described herein, and the same are contemplated within the scope of the illustrative embodiments.

The illustrative embodiments are described with respect to certain social media, social media data sources, events, attributes, products, parameters, NLP processing, business requirements, market characteristics, rules, policies, algorithms, data processing systems, environments, components, and applications only as examples. Any specific manifestations of such artifacts are not intended to be limiting to the invention. Any suitable manifestation of data processing systems, environments, components, and applications can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

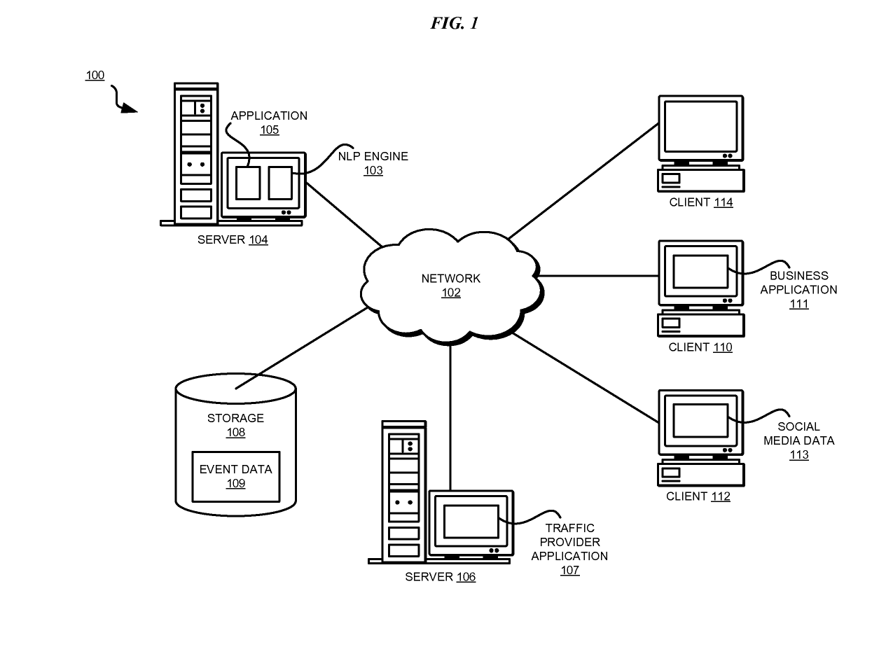

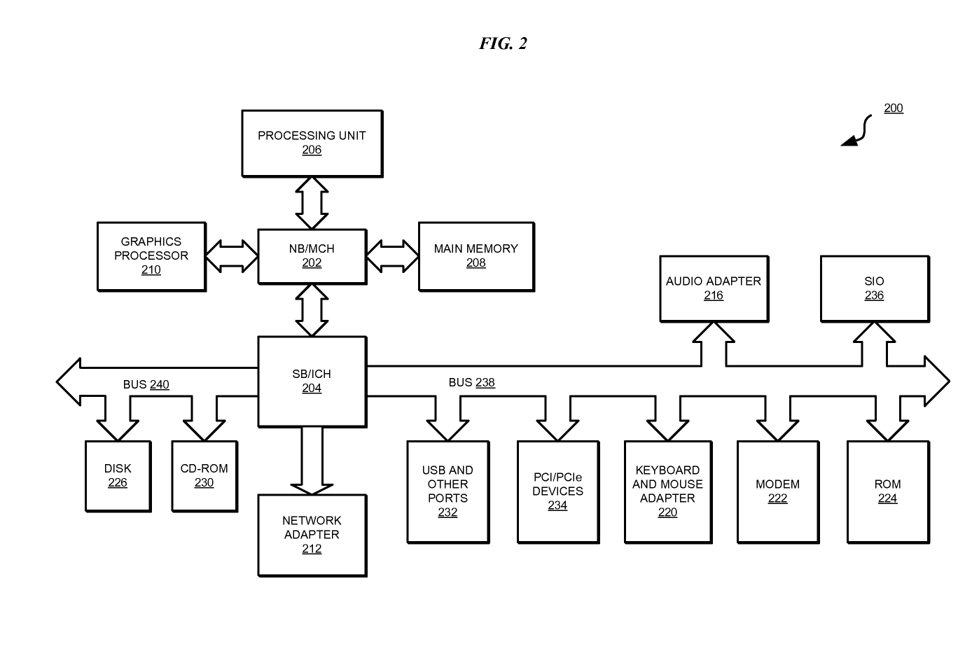

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments.

Application 105 in server 104 implements an embodiment described herein. Application 105 uses NLP engine 103 in the manner described herein. Traffic provider application 107 is an application operated or executed by a service provider who using traffic provider application 107 directs, routes, diverts, or otherwise sends business traffic to business application 111 of a business enterprise. Social media data 113 according to the illustrative embodiments is data of, from, or related to a social media data source, and is located, stored, or accessible from network 102. Event data 109 is generated, stored, and used by application 105 in the manner of an embodiment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as NLP engine 103, application 105, traffic provider application 107, and business application 113 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1 and 2 and above-described examples are not meant to imply architectural limitations. For example, data processing system 200 also may be a tablet computer, laptop computer, or telephone device in addition to taking the form of a PDA.

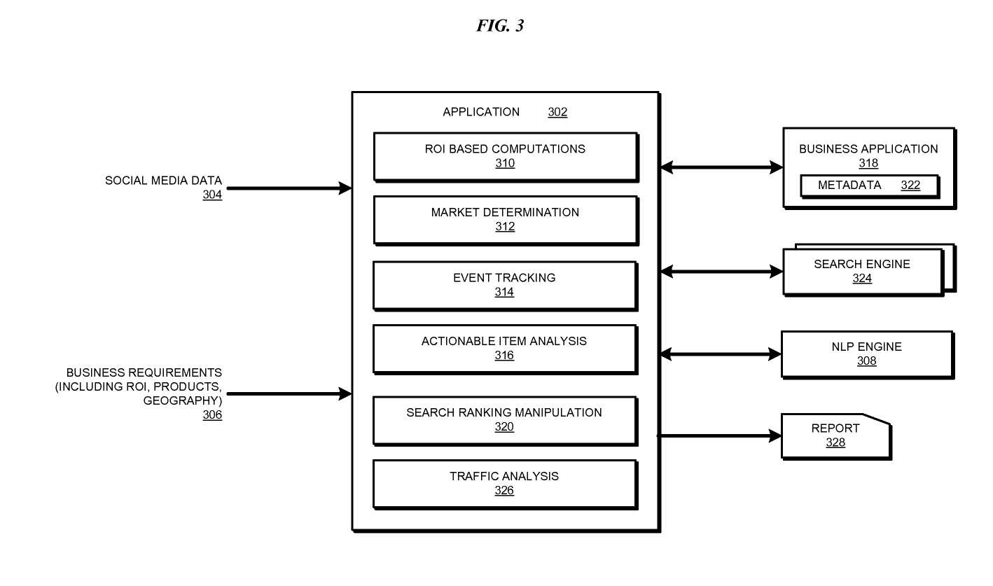

With reference to FIG. 3, this figure depicts a block diagram of an example configuration usable for driving business traffic by predictive analysis of social media in accordance with an illustrative embodiment. Application 302 is an example of application 105 in FIG. 1.

Application 302 receives social media data 304 and business requirements 306 as inputs. Business requirements 306 can include any number or types of requirements, including but not limited to ROI requirements, product parameters, geographical information, and so on. NLP engine 308 is an example of NLP engine 103 in FIG. 1.

Component 310 performs one or more types of ROI based computations. Component 312 determines the market characteristics, and identifies the boundaries or inclusions of a potential market for a product or products. For example, in one embodiment, component 310 operates to help component 312 establish the set of market characteristics according to business requirements 306.

In one embodiment, application 302 uses search engine 324 to search a larger body of social media content to identify social media data 304. For example, component 314 can be configured to first use search engine 324 to identify and/or receive social media data 304, and then perform the operation described below.

Component 314 uses NLP engine 308 to process social media data 304 to extract and store event data, such as event data 109 in FIG. 1. Component 316 analyzes the event data to determine any correspondence between the events and products that can experience increased sales from those events. Events that correlate with one or more products as described elsewhere in this disclosure are deemed actionable, to wit, an embodiment takes further steps to increase business traffic to business application 318 so that the sale of a product supported in business application 318 can be increased.

Component 320 manipulates a part of business application 318 or information of business application 318 to increase business traffic to business application 318. For example, in one embodiment, component 320 modifies metadata 322 so that the product becomes visible or more visible than before in searches conducted using one or more search engines 324. In another embodiment, component 320 manipulates information about business application 318 or a part thereof, e.g., a part pertaining to the product, such that one or more of search engines 324 modifies a listing of business application 318 or the part thereof in search results.

Component 326 performs analysis of the change in the business traffic sent to business application 318 as a result of the operations of an embodiment, and generates one or more report 328. For example, one instance of report 328 is useful for the business enterprise that operates business application 318 to see or validate the ROI requirements using the business traffic data in such a report. Another example instance of report 328 is useful for the traffic service provider, which executes application 302, to determine whether their pricing model for increasing the business traffic to business application 318 and other such business applications is sufficiently profitable or should be adjusted in view of the ROI recognized by the business enterprises.

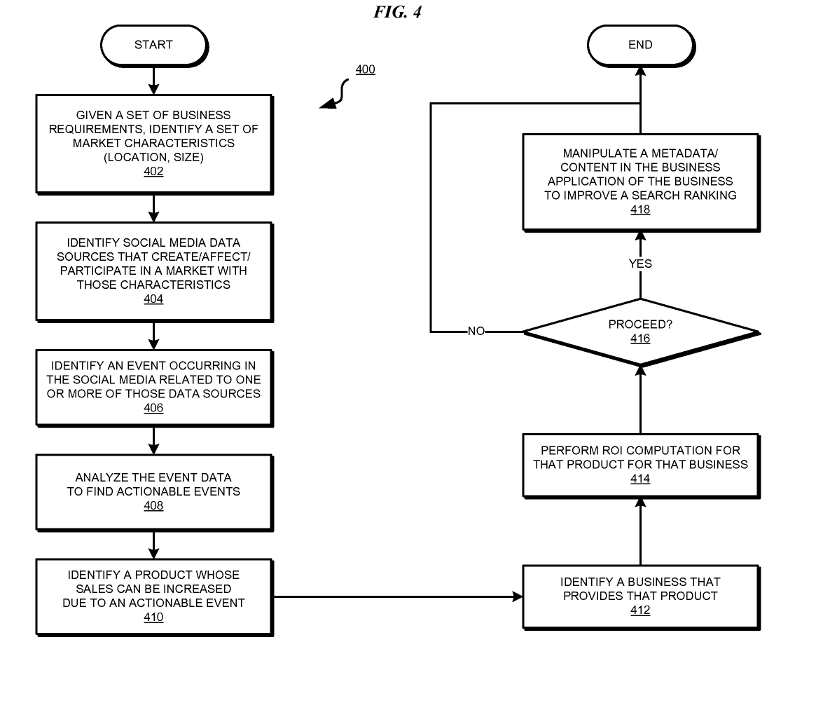

With reference to FIG. 4, this figure depicts an example process for driving business traffic by predictive analysis of social media in accordance with an illustrative embodiment. Process 400 can be implemented in application 302 in FIG. 3.

Given a set of business requirements, the application identifies a set of market characteristics, such as size and location of a desirable group of users (block 402). The application identifies one or more social media data sources that create, affect, or otherwise participate in a market that has some or all of the market characteristics identified in block 402 (block 404).

The application identifies an event occurring in the social media according to the social media data of those social media data sources (block 406). The application generates event data for each such event that is identified in block 406.

The application analyzes the event data to find actionable events, such as by correlating one or more event attributes in the event data with one or more parameters of one or more products (block 408). The application identifies a product whose sales or demand can be increased due to an actionable event (block 410).

The application identifies a business enterprise that provides, sells, or trades in the product identified in block 410 (block 412). The application performs ROI computations for the product from that business enterprise, such as by using the business requirements of that business enterprise (block 414).

The application determines if the ROI computations justify proceeding with operations to increase the demand for the product from that business enterprise (block 416). For example, if information about the availability of the product from the business application of the business enterprise is to be inserted in search results of a search engine, the search engine has to be paid a fee, which forms a cost of increasing the business traffic. In a simplistic ROI calculation, that cost of increasing the business traffic has to be balanced with an expected amount of profitability from the increased business traffic that would likely be generated.

If the ROI computations do not justify proceeding with operations to increase the demand for the product from that business enterprise (“No” path of block 416), the application ends process 400 thereafter. Alternatively (not shown), the application may return process 400 to block 412 for identifying other business enterprises, or to block 410 for identifying other products, and proceeding in a similar manner.

If the ROI computations justify proceeding with operations to increase the demand for the product from that business enterprise (“Yes” path of block 416), the application manipulates a portion of a business application of the identified business enterprise so that the ranking of the information about the product available at the business enterprise is improved in the results of the searches performed in response to the event in the social media (block 418). In one embodiment (not shown), the manipulation of block 418 is with respect to the information about the business application in a search engine, which causes the information about the product availability at the business application to be listed or prioritized in the results of the searches performed in response to the event in the social media.

The application ends process 400 thereafter. Alternatively (not shown), the application may return process 400 to block 412 for identifying other business enterprises, or to block 410 for identifying other products, and proceeding in a similar manner.

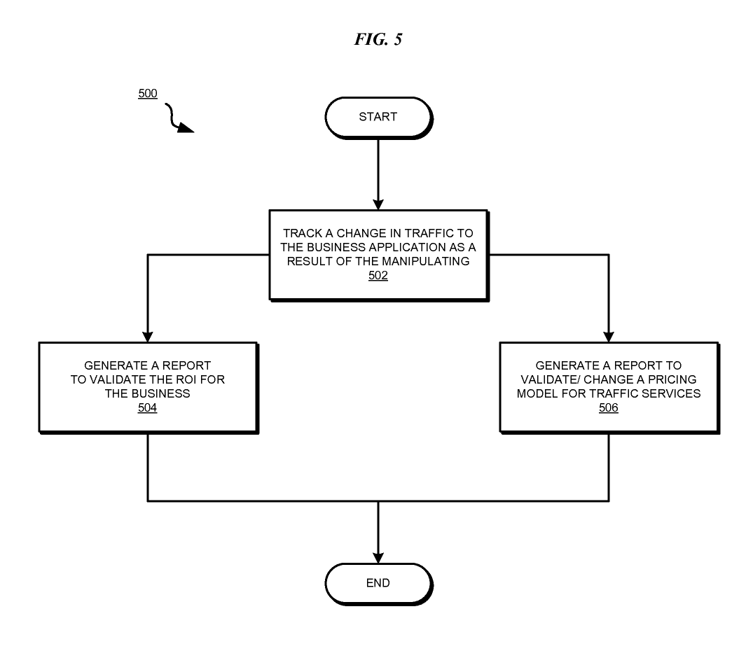

With reference to FIG. 5, this figure depicts a flowchart of another process for using the business traffic data in accordance with an illustrative embodiment. Process 500 can be implemented in application 302 in FIG. 3.

The application tracks a change in the business traffic to the business application resulting from the manipulating of block 418 of process 400 (block 502). The application then generates one or both of the reports of block 504 and 506.

The application generates a report based on the data of the increased business traffic, where the report is usable to validate the ROI for the business enterprise (block 504). Alternatively, or in addition to the report of block 504, the application generates a report based on the data of the increased business traffic, where the report is usable to validate a pricing model used to bill a business enterprise for performing all or part of process 400 in FIG. 4.

Thus, a computer implemented method, system, and computer program product are provided in the illustrative embodiments for driving business traffic by predictive analysis of social media.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for driving business traffic by predictive analysis of social media, the method comprising:
computing, according to a business requirement, a set of characteristics of a market, wherein the market comprises a group of potential buyers of a product;
identifying in a social medium, the market, wherein a data source operates in the market in the social medium;
analyzing a data corresponding to the data source in the social medium to identify a set of attributes of an event occurring in the social medium;
correlating an attribute in the set of attributes with the product; and
manipulating an information associated with a business application such that a search result showing an availability of the product from the business application is promoted in a set of search results produced by a search engine, wherein the set of search results is responsive to a search related to the event in the social medium.

2. The method of claim 1, wherein the manipulating comprises:
changing, in the business application, a product information of the product such that a relation is established between the product and the event, and the search engine lists the business application in the set of search results responsive to the relation.

3. The method of claim 1, wherein the manipulating comprises:
modifying, in the search engine a record of the business application to cause the search engine to list the business application in the set of search results responsive to the search related to the event in the social medium.

4. The method of claim 1, further comprising:
performing a return-on-investment (ROI) computation, wherein the ROI computation establishes that promoting showing the availability of the product from the business application in the set of search results has a greater return than a cost associated with the manipulating.

5. The method of claim 1, further comprising:
generating a report, wherein the report is usable to one of validate and change a pricing model, wherein the pricing model is used for charging a business enterprise a price for the manipulating, wherein the business enterprise operates the business application.

6. The method of claim 1, further comprising:
determining that the attribute in the set of attributes corresponds to a parameter in a set of parameters of the product.

7. The method of claim 1, further comprising:
determining that the attribute in the set of attributes correlates to a plurality of products, the plurality of products including the product;
selecting the product from the plurality of products; and
selecting the business application responsive to selecting the product from the plurality of products.

8. The method of claim 1, wherein the data corresponding to the data source comprises data generated by the data source in the social medium.

9. The method of claim 1, wherein the data corresponding to the data source comprises data that refers to the data source in the social medium.

10. The method of claim 1, wherein the data source comprises a social medium profile, wherein the market comprises a group of social medium users who are associated with the social medium profile.

11. The method of claim 1, wherein the event is trending up in the social medium at the time of analyzing the data.

12. The method of claim 1, further comprising: using a natural language processing (NLP) engine to perform the analyzing of the data.

13. The method of claim 1, wherein the data source creates the market in the social medium.

14. The method of claim 1, further comprising:
identifying in the social medium a set of data sources, the set of data sources collectively affecting the market, wherein the data source in the set of data sources corresponds to a first subset of the characteristics of the market, and wherein another data source in the set of data sources corresponds to a second subset of the characteristics of the market.

15. The method of claim 1, the set of characteristics comprising:
a size of the market, where the size is a number of potential buyers of the product.

16. The method of claim 15, the set of characteristics comprising at least one of (i) a geographical location of the market, (ii) an industry related to the market, and (iii) a demographic composition related to the market.

17. The method of claim 1, wherein the method is embodied in a computer program product comprising one or more computer-readable tangible storage devices and computer-readable program instructions which are stored on the one or more computer-readable tangible storage devices and executed by one or more processors.

18. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

19. A computer program product for driving business traffic by predictive analysis of social media, the computer program product comprising:
one or more computer-readable tangible storage devices;
program instructions, stored on at least one of the one or more storage devices, to compute, according to a business requirement, a set of characteristics of a market, wherein the market comprises a group of potential buyers of a product;
program instructions, stored on at least one of the one or more storage devices, to identify in a social medium, the market, wherein a data source operates in the market in the social medium;
program instructions, stored on at least one of the one or more storage devices, to analyze a data corresponding to the data source in the social medium to identify a set of attributes of an event occurring in the social medium;
program instructions, stored on at least one of the one or more storage devices, to correlate an attribute in the set of attributes with the product; and
program instructions, stored on at least one of the one or more storage devices, to manipulate an information associated with a business application such that a search result showing an availability of the product from the business application is promoted in a set of search results produced by a search engine, wherein the set of search results is responsive to a search related to the event in the social medium.

20. A computer system for driving business traffic by predictive analysis of social media, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to compute, according to a business requirement, a set of characteristics of a market, wherein the market comprises a group of potential buyers of a product;
program instructions, stored on at least one of the one or more storage devices for execution by at least one of the one or more processors via at least one of the one or more memories, to identify in a social medium, the market, wherein a data source operates in the market in the social medium;
program instructions, stored on at least one of the one or more storage devices for execution by at least one of the one or more processors via at least one of the one or more memories, to analyze a data corresponding to the data source in the social medium to identify a set of attributes of an event occurring in the social medium;
program instructions, stored on at least one of the one or more storage devices for execution by at least one of the one or more processors via at least one of the one or more memories, to correlate an attribute in the set of attributes with the product; and
program instructions, stored on at least one of the one or more storage devices for execution by at least one of the one or more processors via at least one of the one or more memories, to manipulate an information associated with a business application such that a search result showing an availability of the product from the business application is promoted in a set of search results produced by a search engine, wherein the set of search results is responsive to a search related to the event in the social medium.
